(19) United States
(12) Patent Application Publication
(10) Pub. No.: US 2002/0185237 A1
(43) Pub. Date: Dec. 12, 2002

(54) Overhead door stop device for freight truck doors

(76) Inventor: Carl Walker, Vista, CA (US)

Correspondence Address: STETINA BRUNDA GARRED & BRUCKER, 75 ENTERPRISE, SUITE 250, ALISO VIEJO, CA, 92656, US

(21) Appl. No.: 09/878,044

(22) Filed: Jun. 11, 2001

(51) Int. Cl. E05F 11/00

(52) U.S. Cl. 160/191

(57) ABSTRACT

An Overhead Doorstop Shock Absorbing Device for Freight Truck Doors as shown in FIG. 1 performs as follows. The overhead door is opened and moves upward until it meets the Overhead Doorstop Shock Absorbing Device, which then absorbs the energy through its springs, thus preventing the overhead door from overextending. This absorption of energy minimizes wear and reduces damage to springs, cables and rollers in current state of the art overhead door assembly systems. This greatly increases financial savings by reducing part consumption, labor costs and downtime.

Due to the high usage of current state of the art overhead doors in freight trucks, problems will continue for the users. By the addition of the Overhead Doorstop Shock Absorbing Device, repairs are minimized and costs are reduced due to the ability of the device to absorb the energy that would otherwise damage the current state of the art overhead door systems.

### BACKGROUND OF THE INVENTION

This invention is concerned with the invention of an Overhead Door Stop Device for Freight Truck Doors which extends the life of current overhead door systems parts of Freight Truck Overhead Door Systems. This invention saves time and money on current available state of the art systems available now.

It is known in the art of Truck Freight Door Manufacturing that high maintenance is a problem due to the current state of the art manufacturing systems of current overhead door systems for freight trucks. This is due to the way they are currently manufactured and used. High usage of Overhead Freight Truck doors going up and down many times per day causes high wear, breakage of parts and in turn high labor cost for repair and replacement of parts on current state of the art systems.

However, in prior art it has not been possible to minimize and almost eliminate high maintenance problems of overhead freight truck doors until this invention. This invention virtually eliminates weekly repairs and in some cases monthly repairs. With the current state of the art, repairs are required on springs, cables and/or rollers of the door assembly system itself daily and weekly. With this new state of the art invention, many of the old state of the art problems are eliminated or exponentially decreased. This new state of the art invention is a cost reducing invention.

### SUMMARY OF THE INVENTION

It has now been discovered that this new state of the art Overhead Door Stop for Freight Trucks exponentially decreases labor and protects parts from wearing out prematurely. Thus, in accordance with an embodiment of the invention, a new state of the art spring absorbing shock assembly device virtually eliminates and significantly reduces annual costs of current state of the art systems of Overhead Doors of Freight Trucks.

### BRIEF DESCRIPTION OF THE DRAWINGS

FIG. 1 is a plain view of the Overhead Doorstop Shock absorbing device. This figure shows the assembled device with springs in place and the bracket that is bolted to the rails of the overhead door assembly of the factory overhead door.

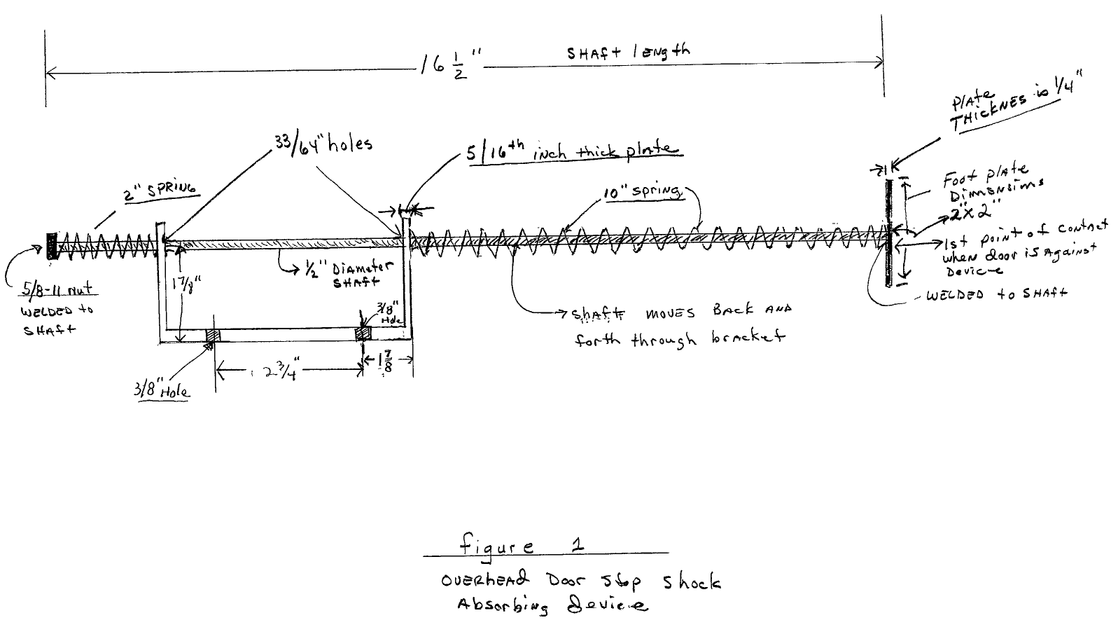

FIG. 2 is a section view of the plate that is drilled with specific holes and the bent portions of the flat plate that originally started out with the dimensions of 9″×3″ and ending up being 5″×3″ with sides being bent upward on both ends . . .

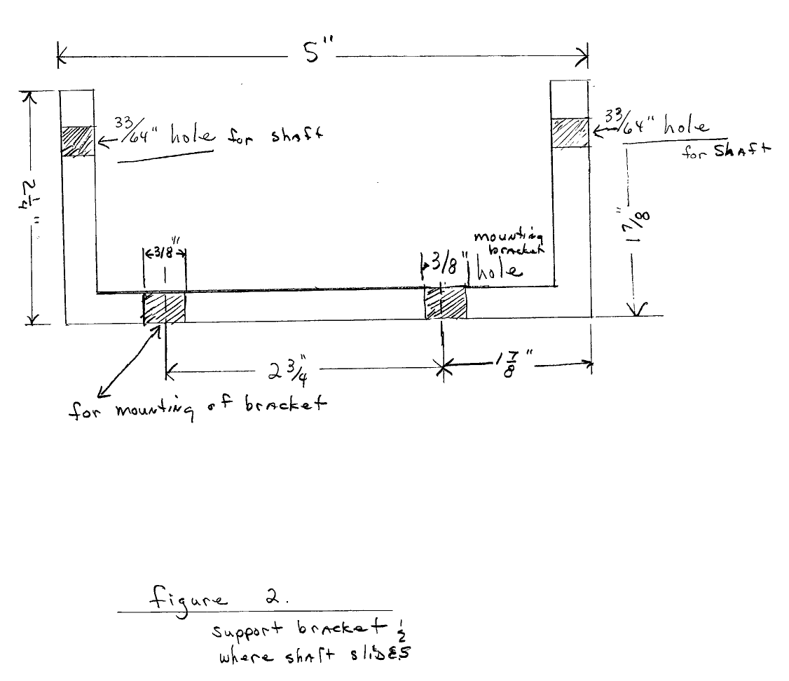

FIG. 3 is a perspective view of where the holes are placed. This view is after the flat plate has been bent upward.

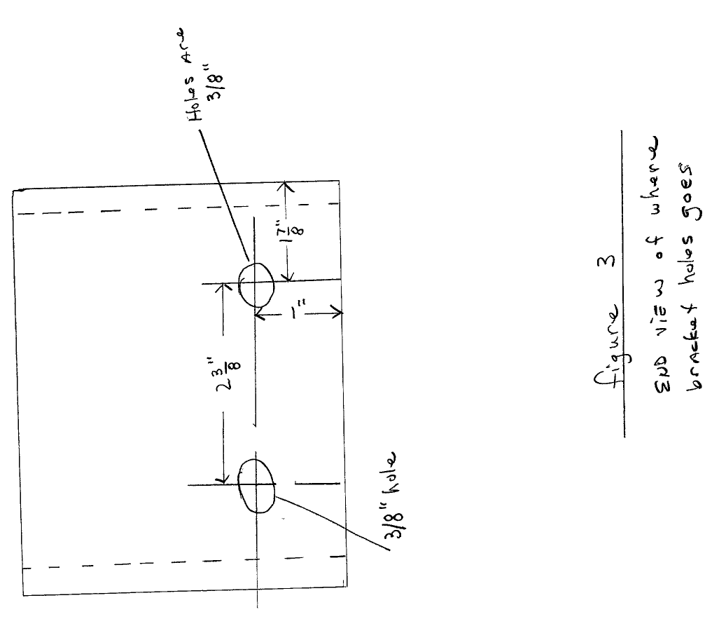

FIG. 4 is an end view of where the holes are drilled to create a shaft carrier.

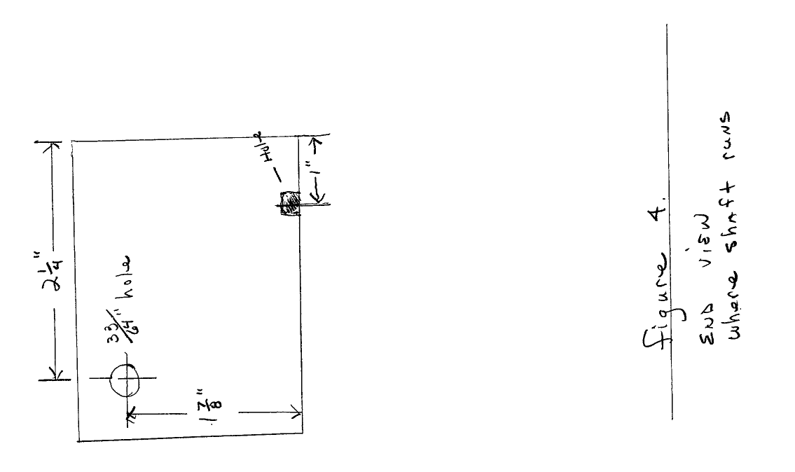

FIG. 5 is a side view of the ½″ round hot rolled steel that is turned into the holder of the springs and bracket plate and shock absorbing device.

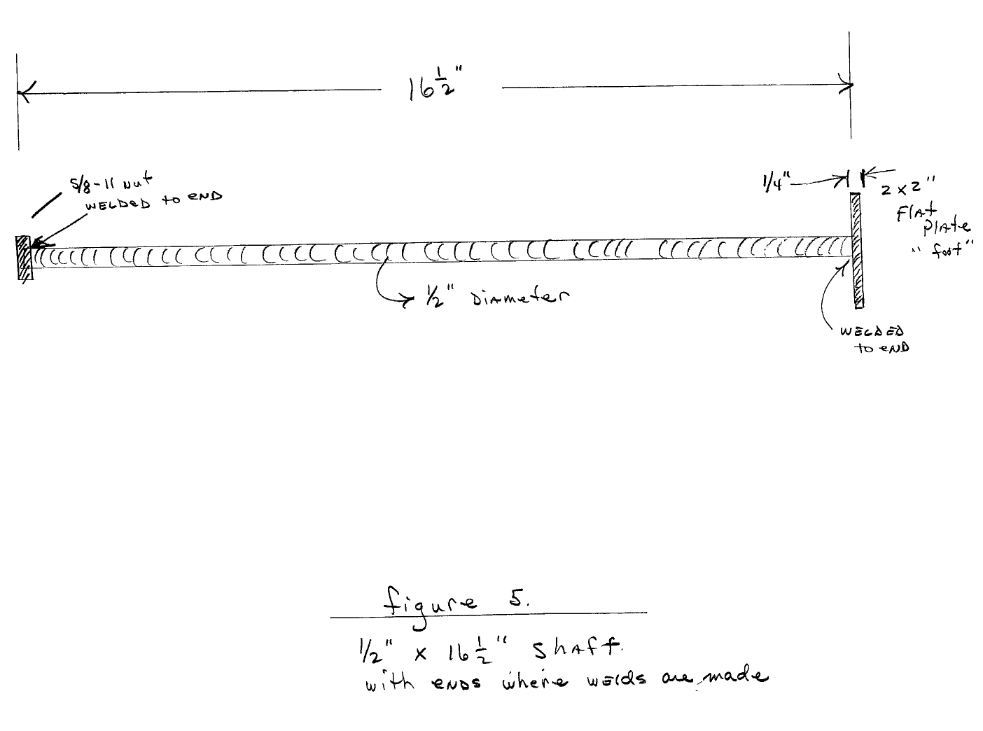

### DESCRIPTION OF THE PREFERRED EMBODIMENT

An overhead shock absorbing doorstop device for freight trucks to prevent damage to springs, rollers and rails on overhead truck doors of freight trucks, comprising:

A ½″ round hot rolled steel shaft 16 & ½″ long to hold springs and mounting devise of said doorstop. A 2″ steel spring to maintain the position of the shaft of said doorstop. A 10″ spring used as the energy shock absorbing device when door of freight truck is opened onto said shock-absorbing device. A mounting plate that is 5″ in length and 3″ wide is then bent on both ends. Said plate that is 3″ wide is used in the construction while a 33/64^{th} inch hole is drilled 2 ¼″ from the right side of 3″ plate and 1⅞^{th} inches up from the bottom of the plate creating a guide and support bracket for the 16½″ shaft.

A ⅝^{th} inch×11 nut is welded to one end. Said end takes the 2″ spring and said spring is placed over the round shaft followed by the bracket, which is then slid onto the shaft touching the spring. The 10″ spring is slid onto shaft after the bracket has been installed. The entire unit is then compressed. A 2×2×¼″ flat plate is welded on the opposite end of where the ⅝″ nut was welded which is a holder of the spring assembly system on one end. Said end plate is held in place by a weld. Said plate is used as a footplate which makes first contact with the overhead truck door when it is opened onto the shock absorbing devise. Two ⅜^{th} inch holes were drilled into the plate that is bent upward. The ⅜^{th} inch holes are a distance of 1⅛^{th} inches from the right side and 1 inch up from the bottom side on the bracket plate. From the point of the first drill hole on the bracket plate another hole 2¾ inches to the left and 1″ up from the bottom is made creating the other ⅜^{th} inch hole for mounting the bracket.

What is claimed is:

1. An overhead shock absorbing doorstop device for freight trucks to prevent damage to springs, rollers and rails on overhead truck doors of freight trucks, comprising:
a. a round hot rolled steel shaft to hold springs and mounting devise of said doorstop.
B. a steel spring to maintain the position of a Plunger of said doorstop.
c. a spring used as an energy shock absorbing spring when door of freight truck is opened onto said shock absorbing doorstop device.
d. a mounting plate creating a shaft guide and support system for said overhead doorstop device.
